(19) United States
(12) Patent Application Publication
(10) Pub. No.: US 2023/0350954 A1
(43) Pub. Date: Nov. 2, 2023

(54) SYSTEMS AND METHODS OF FILTERING TOPICS USING PARTS OF SPEECH TAGGING

(71) Applicant: SparkCognition, Inc., Austin, TX (US)

(72) Inventors: Shashank Bassi, Austin, TX (US); Erik Skiles, Manor, TX (US)

(21) Appl. No.: 17/661,594

(22) Filed: May 2, 2022

(51) Int. Cl. G06F 16/93; G06N 20/00; G06F 40/253; G06F 40/289

(52) U.S. Cl. CPC G06F 16/93; G06N 20/00; G06F 40/253; G06F 40/289

(57) ABSTRACT

A method that includes applying, by one or more processors, a topic model to a document to generate a plurality of topics for the document. Each topic of the plurality of topics includes a corresponding group of words in the document. The method also includes performing a parts of speech (POS) tagging operation on the document to tag each word of a particular topic of the plurality of topics with a first label or a second label. Words tagged with the first label are designated as a first part of speech, and words tagged with the second label are designated as a second part of speech. The method further includes filtering the particular topic from the plurality of topics in response to a determination that each word of the particular topic is tagged with the first label.

### BACKGROUND

A computer system can use machine learning to generate topics that characterize a document. For example, a topic model can be trained using machine learning to identify a cluster of words (e.g., a topic) in the document that can be used to characterize the document. Typically, hyperparameters can be used to train the topic model to generate high-quality topics. For example, the hyperparameters directly control the behavior of a training algorithm for the topic model and have a significant impact on the performance of the topic model. However, tuning the hyperparameters to satisfactorily train the topic model is typically the result of multiple experiments. Even after multiple experiments, it can be challenging to efficiently tune the hyperparameters.

### SUMMARY

A particular aspect of the disclosure describes a method that includes applying, by one or more processors, a topic model to a document to generate a plurality of topics for the document. Each topic of the plurality of topics includes a corresponding group of words in the document. The method also includes performing a parts of speech (POS) tagging operation on the document to tag each word of a particular topic of the plurality of topics with a first label or a second label. Words tagged with the first label are designated as a first part of speech, and words tagged with the second label are designated as a second part of speech. The method further includes filtering the particular topic from the plurality of topics in response to a determination that each word of the particular topic is tagged with the first label.

Another particular aspect of the disclosure describes a device that includes one or more processors and one or more memory devices accessible to the one or more processors. The one or more memory devices store instructions that are executable by the one or more processors to cause the one or more processors to apply a topic model to a document to generate a plurality of topics for the document. Each topic of the plurality of topics includes a corresponding group of words in the document. The instructions are further executable by the one or more processors to cause the one or more processors to perform a parts of speech (POS) tagging operation on the document to tag each word of a particular topic of the plurality of topics with a first label or a second label. Words tagged with the first label are designated as a first part of speech, and words tagged with the second label are designated as a second part of speech. The instructions are further executable by the one or more processors to cause the one or more processors to filter the particular topic from the plurality of topics in response to a determination that each word of the particular topic is tagged with the first label.

Another particular aspect of the disclosure describes a computer-readable storage device that stores instructions that are executable by one or more processors to perform operations. The operations include applying a topic model to a document to generate a plurality of topics for the document. Each topic of the plurality of topics includes a corresponding group of words in the document. The operations also include performing a parts of speech (POS) tagging operation on the document to tag each word of a particular topic of the plurality of topics with a first label or a second label. Words tagged with the first label are designated as a first part of speech, and words tagged with the second label are designated as a second part of speech. The operations further include filtering the particular topic from the plurality of topics in response to a determination that each word of the particular topic is tagged with the first label.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 illustrates a particular embodiment of a system that is generally operable to filter topics based on parts of speech tagging.

FIG. 2 illustrates another particular embodiment of a system that is generally operable to filter topics based on parts of speech tagging.

FIG. 3 depicts a document that includes filtered words and topics based on parts of speech tagging.

FIG. 4 illustrates a flowchart of a particular example of a method of filtering topics based on parts of speech tagging.

FIG. 5 is a diagram of a particular example of a system to generate and train a model to filter topics based on parts of speech tagging in accordance with some examples of the present disclosure.

FIG. 6 is a block diagram of a computer system configured to initiate, perform, or control one or more of the operations described with reference to FIGS. 1-5.

### DETAILED DESCRIPTION

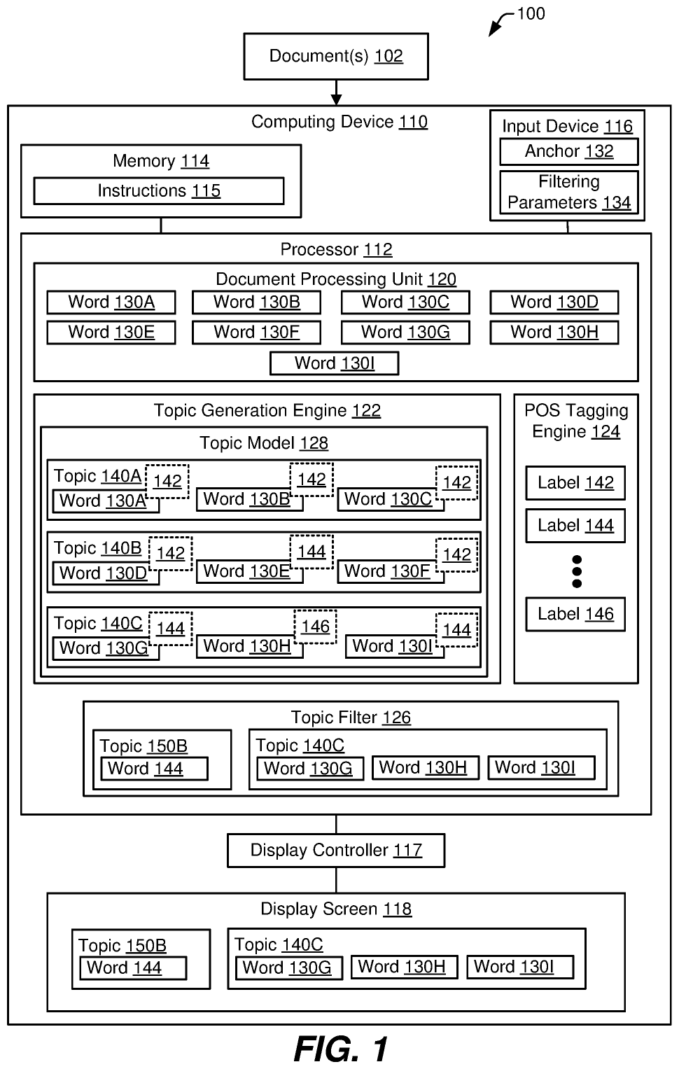

Particular aspects of the present disclosure are described below with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, topics are illustrated and associated with reference numbers 140A, 140B, and 140C. When referring to a particular topic 140, such as the topic 140A, the distinguishing letter “A” is used. However, when referring to any arbitrary topic or the topics as a group, the reference number 140 is used without a distinguishing letter.

As used herein, various terminology describing particular implementations is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

FIG. 1 illustrates a particular embodiment of a system 100 that is generally operable to filter topics based on parts of speech (POS) tagging. For example the system 100 includes a computing device 110 that is operable to identify different topics 140 in one or more documents 102 and filter the topics 140 based on a POS tagging operation.

The computing device 110 includes a processor 112, a memory 114 coupled to the processor 112, an input device 116 coupled to the processor 112, a display controller 117 coupled to the processor 112, and a display screen 118 coupled to the display controller 117. The memory 114 may be a non-transitory computer-readable device or medium that stores instructions 115 executable by the processor 112. For example, the instructions 115 are executable by the processor 112, or by components within the processor 112, to perform the operations described herein.

The processor 112 includes a document processing unit 120, a topic generation engine 122, a POS tagging engine 124, and a topic filter 126. The processor 112 is configured to execute the topic generation engine 122 and the POS tagging engine 124 to perform the operations described herein. According to some implementations, one or more components of the processor 112 can be implemented using dedicated circuitry, such as an application-specific integrated circuit (ASIC) or a field programmable gate array (FPGA). According to some implementations, one or more components of the processor 112 can be implemented using software (e.g., instructions 115 executable by the processor 112).

The document processing unit 120 is configured to extract one or more words 130 from the one or more documents 102. For example, the document processing unit 120 can initiate a scan of the one or more documents 102 for processing or can upload the one or more documents 102 for processing. The document processing unit 120 can operate as a text extractor that enables the processor 112 to extract text from the one or more documents 102. Based on the extracted text and spacing between the extracted text, the document processing unit 120 can identify one or more words 130.

In the illustrated example of FIG. 1, the document processing unit 120 can identify a word 130A, a word 130B, a word 130C, a word 130D, a word 130E, a word 130F, a word 130G, a word 130H, and a word 130I. Although nine words 130 are depicted as being identified in the one or more documents 102 by the document processing unit 120, in other implementations, additional (or fewer) words can be identified by the document processing unit 120. Additionally, in other implementations, the document processing unit 120 can use other techniques to identify the words 130 in the one or more documents 102. As a non-limiting example, the document processing unit 120 can convert the one or more documents 102 into a machine-readable word processing format using letter recognition and identify the words 130 based on the machine-readable word processing version of the one or more documents 102.

The topic generation engine 122 is configured to apply a topic model 128 to the one or more documents 102 to generate a plurality of topics 140 for the one or more documents 102. According to one implementation, applying the topic model 128 includes generating input data for one or more topic models based on content (e.g., text) of the one or more documents 102 and providing the input data to the topic model 128. In a particular implementation, the input data includes word embeddings representing words from the one or more documents 102. The topic model 128 is a machine-learning model that generates the topics 140 based on one or more inputs (e.g., the input data). The topics are particular words or sets of words (e.g., phrases) that the topic model 128 identifies as particularly representative of information content of the one or more documents. As a non-limiting example, the topic model 128 can correspond to a Correlation Explanation (CorEx) topic model and a user can designate an anchor 132 (e.g., one or more anchor words) using the input device 116. In this example, the CorEx topic model is trained to identify as topics for one or more documents, the set of words that are maximally informative (within specified boundary conditions) regarding the content of the one or more documents. Based on the anchor 132, the topic generation engine 122 can generate the plurality of topics 140 using the topic model 128. For example, the anchor 132 enables the user to designate parameters that instruct the topic model 128 on how to cluster words 130 for the different topics 140, how to cluster other sparse data, etc. Although a CorEx topic model is described, in other implementations, different topic models can be implemented by the topic generation engine 122.

In the example of FIG. 1, in response to applying the topic model 128 to the one or more documents 102, the topic generation engine 122 can generate a topic 140A, a topic 140B, and a topic 140C. As used herein, each topic 140 corresponds to a group of words 130 in the one or more documents 102 that are clustered together. Although three topics 140 are illustrated, in other implementations, the topic generation engine 122 can generate additional (or fewer) topics. As a non-limiting example, in some implementations, the topic generation engine 122 can generate thousands of topics 140 for a particular document. According to one implementation, a single topic is generated for each document of the one or more documents 102. As a non-limiting example, the topic 140A is generated for a first document of the one or more documents 102, the topic 140B is generated for a second document of the one or more documents 102, and the topic 140C is generated for a third document of the one or more documents. According to another implementation, two or more of the topics 140A-140C are generated for a single document of the one or more documents 102. As a non-limiting example, the topics 140A, 140B, 140C can be generated for a single document 102. In some scenarios, at least two of the topics 140 can be generated for a section of the document 102. In other scenarios, at least two of the topics 140 can be generated for a paragraph of the document 102.

The topic 140A includes the word 130A, the word 130B, and the word 130C. The topic 140B includes the word 130D, the word 130E, and the word 130F. The topic 140C includes the word 130G, the word 130H, and the word 130I. Although three words 130 are included in each topic 140, it should be understood that in other implementations, a topic 140 can include additional (or fewer) words 130. As a non-limiting example, in one implementation, a topic 140 can include ten words. As another non-limiting example, in one implementation, a topic 140 can include two words. The topics 140 generated by the topic generation engine 122 can be used to classify the one or more documents 102. Additionally, in some implementations, a common word 130 can appear in different topics 140. As a non-limiting example, in some implementations, the word 130D can be included in the topic 140A and the topic 140B.

However, in some scenarios, the topics 140 can include a plurality of words 130 that are not helpful in classifying the one or more documents 102. As a non-limiting example, some of the words 130 in a particular topic 140 can correspond to parts of speech that do not provide context of the one or more documents 102, such as adjectives, adverbs, pronouns, etc. To facilitate selection of more useful topics, the POS tagging engine 124 and the topic filter 126 can operate in tandem to filter different parts of speech from the topics 140 and generate higher quality topics.

To illustrate, the POS tagging engine 124 is configured to tag each word 130 in the topics with a label 142, a label 144, or a label 146. Each label 142, 144, 146 can indicate a part of speech associated with a corresponding tagged word. To illustrate, the label 142 can correspond to a first part of speech, the label 144 can correspond to a second part of speech, the label 146 can correspond to a third part of speech, etc. According to one implementation, the first part of speech associated with the label 142 can correspond to a verb, the second part of speech associated with the label 144 can correspond to a noun, the third part of speech associated with the label 146 can correspond to an adjective, etc. It should be understood that the above labels and label indications are merely for illustrative purposes and should not be constructed as limiting. In other scenarios, the POS tagging engine 124 can select from a greater amount of labels, such as five labels. In yet other scenarios, the labels can indicate different parts of speech, such as an adverb, a pronoun, a preposition, a conjunction, a determiner, an interjection, etc.

As illustrated in the example of FIG. 1, the POS tagging engine 124 can perform a POS operation on the one or more documents 102 to tag (e.g., assign) each word 130A-130C of the topic 140A with a label. In the example of FIG. 1, the POS tagging engine 124 tags each word 130A-130C in the topic 140A with the label 142. The POS tagging engine 124 can also perform a POS operation on the one or more documents 102 to tag each word 130D-130F of the topic 140B with a label. In the example of FIG. 1, the POS tagging engine 124 tags the word 130D with the label 142, tags the word 130E with the label 144, and tags the word 130F with the label 142. The POS tagging engine 124 can also perform a POS operation on the one or more documents 102 to tag each word 130G-130I of the topic 140C with a label. In the example of FIG. 1, the POS tagging engine 124 tags the word 130G with the label 144, tags the word 130H with the label 146, and tags the word 130I with the label 144. Thus, after a POS operation is performed on the one or more documents 102, the words 130 of each topic 140 are assigned a label.

The topic filter 126 is configured to filter each topic 140 based on the assigned labels 142-146. For ease of description, the following scenario assumes that the first part of speech (as indicated by the label 142) is a verb, the second part of speech (as indicated by the label 144) is a noun, and the third part of speech (as indicated by the label 146) is an adverb. The topic filter 126 can be configured to remove the first part of speech (e.g., verbs) from each topic 140. To illustrate, the topic filter 126 can filter and remove the topic 140A from the plurality of topics 140 in response to a determination that each word 130A-130C of the topic 140A is tagged with the label 142. For example, the topic filter 126 can remove the particular topic 140A from the topics 140 generated by the topic generation engine 122. The topic filter 126 can also determine that a subset of words 130D, 130F of the topic 140B are tagged with the label 142. In response to determining that the subset of words 130D, 130F are tagged with the label 142, the topic filter 126 can filter the subset of words 130D, 130F from the topic 140B to generate a filtered topic 150B. For example, the topic filter 126 can remove the subset of words 130D, 130F from the topic 140B to generate the filtered topic 150B. Because no words are tagged with the label 142 in the topic 140C, the topic filter 126 can bypass removal of words 130 from the topic 140C.

It should be understood that the above scenario is merely for illustrative purposes and different labels 142-146 can be used to filter the topics 140A-140C. For example, in some scenarios, words 130 that are tagged with the label 144 can be filtered and removed from the topics 140. In other scenarios, words 130 that are tagged with the label 142 and the label 146 can be filtered and removed from the topics 140. Filtering parameters 134 for the topic filter 126 can be set and adjusted by the user. For example, using the input device 116, the user can control which labels 142-146 are used to filter the topics 140 generated by the topic generation engine 122. Thus, the user can control generation of the topics 140 by setting the anchor 132 and can control how the topics 140 are filtered by setting the filtering parameters 134.

Upon generation, the display controller 117 can output the filtered topics 150B, 140C to the display screen 118. The filtered topics 150B, 140C can be viewed by the user to classify the one or more documents 102.

The techniques described with respect to FIG. 1 enable generation of high-quality topics using a topic model 128 that is trained with a reduced focus on hyperparameter tuning. For example, the topic model 128 can be trained using node weights. Although training the topic model 128 using node weights can sometimes result in topics 140 that are lesser quality topics than topics generated using a topic model that is heavily influenced by hyperparameter training, the techniques described with respect to FIG. 1 enable the topics 140 to be filtered using POS tagging to generate higher quality topics. For example, by indicating the parts of speech for each word 130 in the topics 140 generated by the topic model 128, the system 100 can filter and remove the topics 140 to generate higher quality topics.

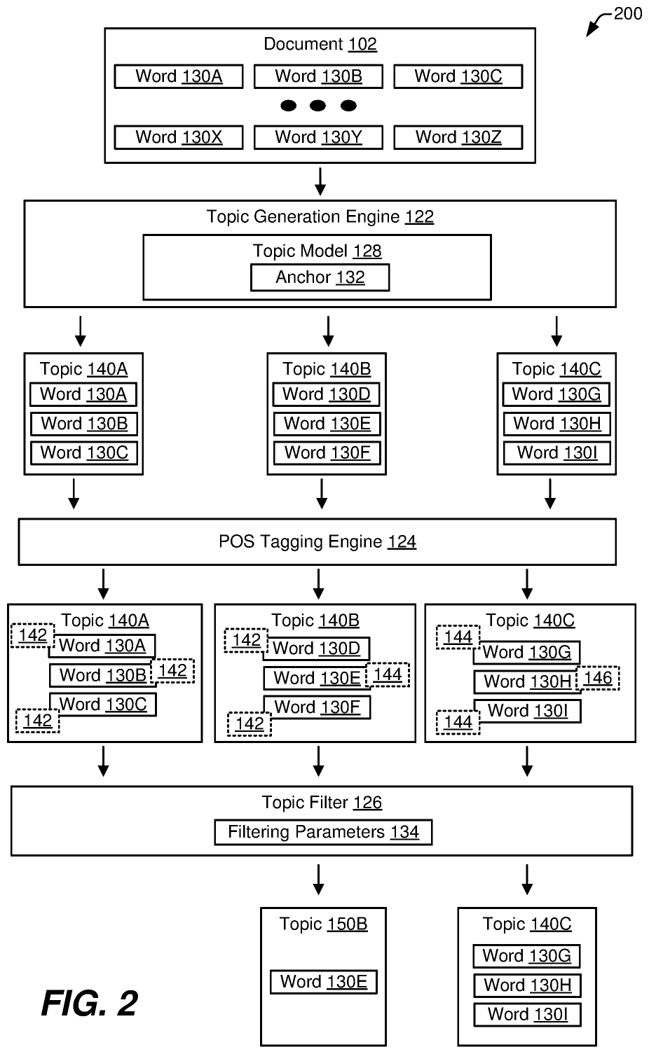

FIG. 2 illustrates another particular embodiment of a system 200 that is generally operable to filter topics based on POS tagging. In particular, the system 200 illustrates the operations performed by the processor 112 to filter topics using POS tagging. The system 200 includes the topic generation engine 122, the POS tagging engine 124, and the topic filter 126.

In the example of FIG. 2, the topic generation engine 122 generates the topics 140A-140C from the one or more documents 102. To illustrate, the one or more documents 102 includes a plurality of words 130A-130Z. The topic generation engine 122 identifies different clusters (e.g., groups) of words 130 and generates the topics 140A-140C. For example, the topic generation engine 122 can apply the topic model 128 to the one or more documents 102 to generate the plurality of topics 140 for the one or more documents 102. According to one implementation, the topic model 128 can correspond to a machine-learning model that generates the topics 140 based on one or more inputs. As a non-limiting example, the topic model 128 can correspond to a Correlation Explanation (CorEx) topic model and a user can designate an anchor 132 (e.g., one or more anchor words) using the input device 116. Based on the anchor 132, the topic generation engine 122 can generate the plurality of topics 140 using the topic model 128.

In the example of FIG. 2, in response to applying the topic model 128 to the one or more documents 102, the topic generation engine 122 can generate the topic 140A, the topic 140B, and the topic 140C. The topic 140A includes the word 130A, the word 130B, and the word 130C. The topic 140B includes the word 130D, the word 130E, and the word 130F. The topic 140C includes the word 130G, the word 130H, and the word 130I. Although the words 130X, 130Y, 130Z are not included in a topic 140 in the example of FIG. 2, in other implementations, the words 130X, 130Y, 130Z can also be included in one or more topics 140.

The POS tagging engine 124 can tag each word 130 in the one or more documents 102 with the label 142, the label 144, or the label 146. As illustrated in the example of FIG. 2, the POS tagging engine 124 can perform a POS operation on the one or more documents 102 to tag each word 130A-130C of the topic 140A with a label. In the example of FIG. 2, the POS tagging engine 124 tags each word 130A-130C in the topic 140A with the label 142. The POS tagging engine 124 can also perform the POS operation on the one or more documents 102 to tag each word 130D-130F of the topic 140B with a label. In the example of FIG. 2, the POS tagging engine 124 tags the word 130D with the label 142, tags the word 130E with the label 144, and tags the word 130F with the label 142. The POS tagging engine 124 can also perform the POS operation on the one or more documents 102 to tag each word 130G-130I of the topic 140C with a label. In the example of FIG. 2, the POS tagging engine 124 tags the word 130G with the label 144, tags the word 130H with the label 146, and tags the word 130I with the label 144.

The topic filter 126 can filter each topic 140 based on the labels 142-146. For ease of description, the following scenario assumes that the first part of speech (as indicated by the label 142) is a verb, the second part of speech (as indicated by the label 144) is a noun, and the third part of speech (as indicated by the label 146) is an adverb. The topic filter 126 can filter and remove the first part of speech (e.g., verbs) from each topic 140. To illustrate, the topic filter 126 can filter and remove the topic 140A from the plurality of topics 140 in response to a determination that each word 130A-130C of the topic 140A is tagged with the label 142. For example, the topic filter 126 can remove the particular topic 140A from the topics 140 generated by the topic generation engine 122. The topic filter 126 can also determine that a subset of words 130D, 130F of the topic 140B are tagged with the label 142. In response to determining that the subset of words 130D, 130F are tagged with the label 142, the topic filter 126 can filter and remove the subset of words 130D, 130F from the topic 140B to generate a filtered topic 150B. For example, the topic filter 126 can remove the subset of words 130D, 130F from the topic 140B to generate the filtered topic 150B. Because no words are tagged with the label 142 in the topic 140C, the topic filter 126 can bypass removal of words 130 from the topic 140C.

The techniques described with respect to FIG. 2 enable generation of high-quality topics using a topic model 128 that is trained with a reduced focus on hyperparameter tuning. For example, the topic model 128 can be trained using node weights. Although training the topic model 128 using node weights can sometimes result in topics 140 that are lesser quality topics than topics generated using a topic model that is heavily influenced by hyperparameter training, the techniques described with respect to FIG. 1 enable the topics 140 to be filtered using POS tagging to generate higher quality topics. For example, by indicating the parts of speech for each word 130 in the topics 140 generated by the topic model 128, the system 100 can filter the topics 140 to generate higher quality topics.

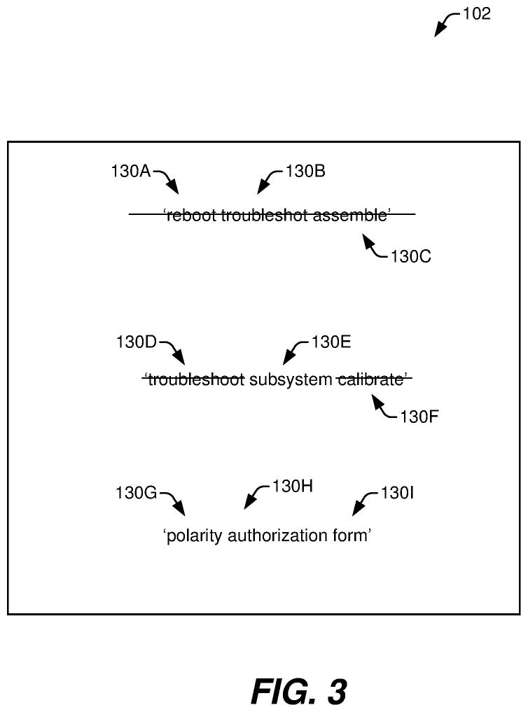

FIG. 3 depicts the document 102 that includes filtered words and topics based on parts of speech tagging. The document 102 includes the words 130A-130I. In the example illustrated in FIG. 3, the word 130A is “reboot,” the word 130B is “troubleshoot,” the word 130C is “assemble,” the word 130D is “troubleshoot”, the word 130E is “subsystem,” the word 130F is “calibrate,” the word 130G is “polarity,” the word 130H is “authorization,” and the word 130I is “form.” The words 130A-130I depicted in FIG. 3 are merely for illustrative purposes and should not be construed as limiting. As described with respect to FIGS. 1-2, the words 130A-130C are included in the topic 140A, the words 130D-130F are included in the topic 140B, and the words 130G-130I are included in the topic 140C.

The words 130 that are stricken through in the document are filtered (e.g., removed) from the respective topic. Assuming that the first part of speech associated with the label 142 is a verb, the topic filter 126 is configured to filter (e.g., strike through or remove) the verbs from the document 102. Thus, the words 130A, 130B, 130C, 130D, 130F are stricken through. As a result, the topic 140A is removed as all of the words 130A-130C in the topic 140 are stricken through. A subset of the words in the topic 140B is filtered such that the word 130E is the only word in topic 140B that remains. The words 130G-130I remain unfiltered.

Thus, the topics in the document 102 can be filtered based on the POS tagging to generate higher quality topics. For example, by indicating the parts of speech for each word 130 in the topics 140 generated by the topic model 128, words associated with undesired parts of speech can be filtered from the topics 140 to generate higher quality topics.

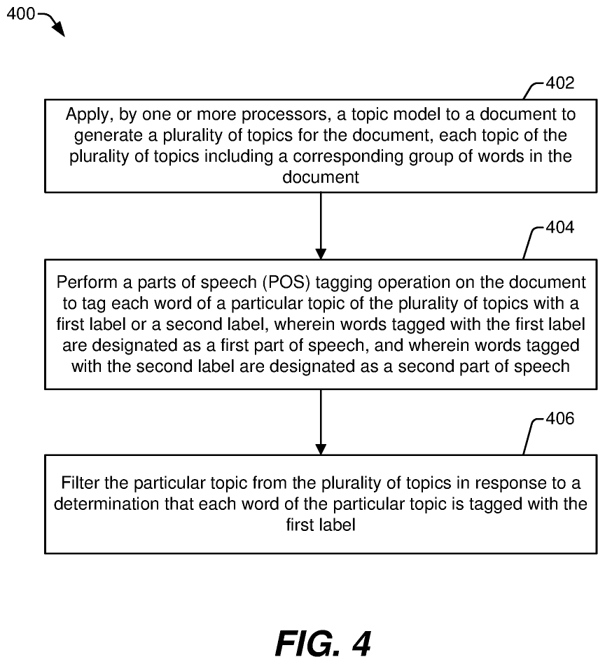

FIG. 4 illustrates a flowchart of a particular example of a method 400 of filtering topics based on parts of speech tagging. The method 400 may correspond to operations performed by the processor 112. In particular, the method 400 may correspond to the operations described with respect to FIGS. 1-3.

The method 400 includes applying, by one or more processors, a topic model to a document to generate a plurality of topics for the document, at block 402. Each topic of the plurality of topics includes a corresponding group of words in the document. For example, referring to FIGS. 1-2, the topic generation engine 122 applies the topic model 128 to the document 102 to generate the plurality of topics 140. Each topic 140A-140C of the plurality of topics 140 includes a corresponding group of words 130 in the document 102.

The method 400 also includes performing a POS tagging operation on the document to tag each word of a particular topic of the plurality of topics with a first label or a second label, at block 404. Words tagged with the first label are designated as a first part of speech, and words tagged with the second label are designated as a second part of speech. For example, referring to FIGS. 1-2, the POS tagging engine 124 performs a POS tagging operation on the topic 140A of the plurality of topics 140 to tag each word 130A-130C of the topic 140A with the label 142 or the label 144. In some scenarios, as illustrated in FIG. 1, the POS tagging engine 124 can also have the option to tag one or more of the words 130A-130C with another label, such as the label 146. Words 130 tagged with the label 142 are designated as a first part of speech, and words 130 tagged with the label 144 are designated as a second part of speech. According to one implementation of the method 400, the first part of speech corresponds to a verb. According to one implementation of the method 400, the second part of speech corresponds to a noun or a pronoun. It should be understood that the first part of speech (or the second part of speech) can correspond to one of an adjective, an adverb, a pronoun, a preposition, a conjunction, a determiner, or an interjection.

The method 400 also includes filtering the particular topic from the plurality of topics in response to a determination that each word of the particular topic is tagged with the first label, at block 406. For example, referring to FIGS. 1-2, the topic filter 126 filters and removes the topic 140A in response to the determination that each word 130A-130C of the topic 140A is tagged with the label 142. According to one implementation of the method 400, filtering the particular topic from the plurality of topics includes removing the particular topic from the plurality of topics.

According to one implementation, the method 400 includes performing the POS tagging operation on the document to tag each word of a second particular topic of the plurality of topics with the first label or the second label. For example, referring to FIGS. 1-2, the POS tagging engine 124 tags each word 130D-130F of the topic 140B with the label 142 or the label 144. The method 400 can also include determining that a subset of the words of the second particular topic are tagged with the first label. For example, referring to FIGS. 1-2, the topic filter 126 determines that words 130D, 130F are tagged with the label 142. The method 400 can also include filtering the subset of words of the second particular topic from the second particular topic to generate a filtered second particular topic. For example, referring to FIGS. 1-2, the topic filter 126 filters and removes the words 130D, 130F from the topic to generate the filtered topic 150B. The filtered topic 150B is usable to classify the document 102. According to one implementation of the method 400, filtering the subset of the words of the second particular topic includes removing the subset of the words of the second particular topic from the second particular topic.

The method 400 of FIG. 4 enables generation of high-quality topics using a topic model 128 that is trained with a reduced focus on hyperparameter tuning. For example, the topic model 128 can be trained using node weights. Although training the topic model 128 using node weights can sometimes result in topics 140 that are lesser quality topics than topics generated using a topic model that is heavily influenced by hyperparameter training, the techniques described with respect to FIG. 1 enable the topics 140 to be filtered using POS tagging to generate higher quality topics. For example, by indicating the parts of speech for each word 130 in the topics 140 generated by the topic model 128, the system 100 can filter the topics 140 to generate higher quality topics

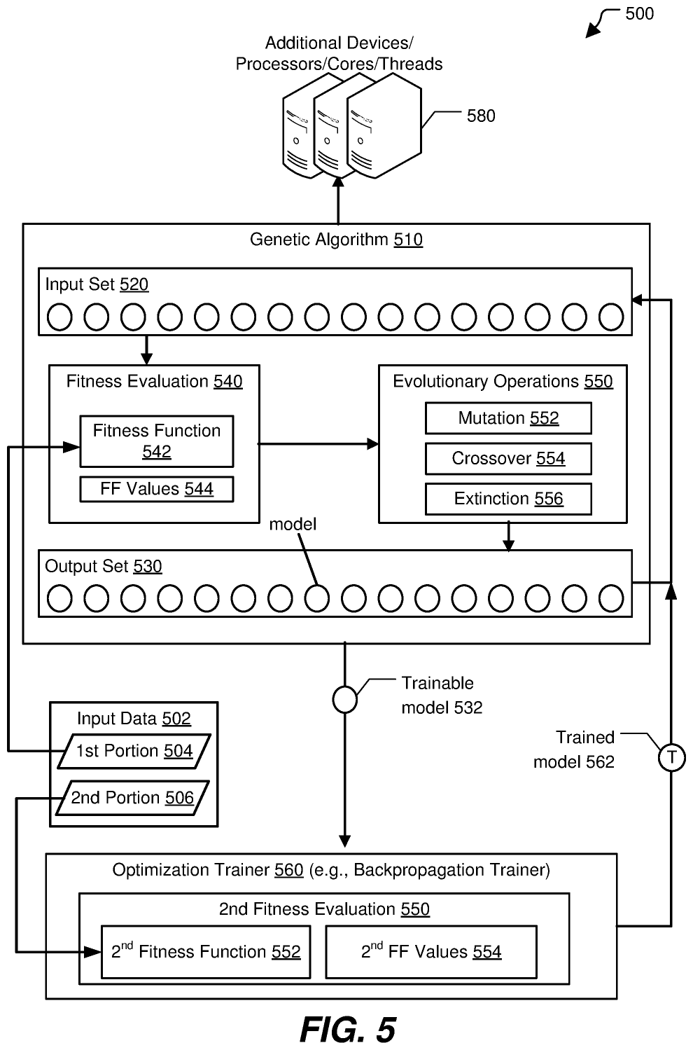

Referring to FIG. 5, a particular illustrative example of a system 500 for generating a machine-learning data model, such as topic model 128, that can be used by the processors 112, the computing device 110, or both, is shown. Although FIG. 5 depicts a particular example for purpose of explanation, in other implementations other systems may be used for generating or updating the topic model 128.

The system 500, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the system 500 includes a genetic algorithm 510 and an optimization trainer 560. The optimization trainer 560 is, for example, a backpropagation trainer, a derivative free optimizer (DFO), an extreme learning machine (ELM), etc. In particular implementations, the genetic algorithm 510 is executed on a different device, processor (e.g., central processor unit (CPU), graphics processing unit (GPU) or other type of processor), processor core, and/or thread (e.g., hardware or software thread) than the optimization trainer 560. The genetic algorithm 510 and the optimization trainer 560 are executed cooperatively to automatically generate a machine-learning data model (e.g., the topic model 128, such as depicted in FIG. 1 and referred to herein as “models” for ease of reference), such as a neural network or an autoencoder, based on the input data 502. The system 500 performs an automated model building process that enables users, including inexperienced users, to quickly and easily build highly accurate models based on a specified data set.

During configuration of the system 500, a user specifies the input data 502. In some implementations, the user can also specify one or more characteristics of models that can be generated. In such implementations, the system 500 constrains models processed by the genetic algorithm 510 to those that have the one or more specified characteristics. For example, the specified characteristics can constrain allowed model topologies (e.g., to include no more than a specified number of input nodes or output nodes, no more than a specified number of hidden layers, no recurrent loops, etc.). Constraining the characteristics of the models can reduce the computing resources (e.g., time, memory, processor cycles, etc.) needed to converge to a final model, can reduce the computing resources needed to use the model (e.g., by simplifying the model), or both.

The user can configure aspects of the genetic algorithm 510 via input to graphical user interfaces (GUIs). For example, the user may provide input to limit a number of epochs that will be executed by the genetic algorithm 510. Alternatively, the user may specify a time limit indicating an amount of time that the genetic algorithm 510 has to execute before outputting a final output model, and the genetic algorithm 510 may determine a number of epochs that will be executed based on the specified time limit. To illustrate, an initial epoch of the genetic algorithm 510 may be timed (e.g., using a hardware or software timer at the computing device executing the genetic algorithm 510), and a total number of epochs that are to be executed within the specified time limit may be determined accordingly. As another example, the user may constrain a number of models evaluated in each epoch, for example by constraining the size of an input set 520 of models and/or an output set 530 of models.

The genetic algorithm 510 represents a recursive search process. Consequently, each iteration of the search process (also called an epoch or generation of the genetic algorithm 510) has an input set 520 of models (also referred to herein as an input population) and an output set 530 of models (also referred to herein as an output population). The input set 520 and the output set 530 may each include a plurality of models, where each model includes data representative of a machine-learning data model. For example, each model may specify a neural network or an autoencoder by at least an architecture, a series of activation functions, and connection weights. The architecture (also referred to herein as a topology) of a model includes a configuration of layers or nodes and connections therebetween. The models may also be specified to include other parameters, including but not limited to bias values/functions and aggregation functions.

For example, each model can be represented by a set of parameters or a set of hyperparameters. In this context, the hyperparameters of a model define the architecture of the model (e.g., the specific arrangement of layers or nodes and connections), and the parameters of the model refer to values that are learned or updated during optimization training of the model. For example, the parameters include or correspond to connection weights and biases.

In a particular implementation, a model is represented as a set of nodes and connections therebetween. In such implementations, the hyperparameters of the model include the data descriptive of each of the nodes, such as an activation function of each node, an aggregation function of each node, and data describing node pairs linked by corresponding connections. The activation function of a node is a step function, sine function, continuous or piecewise linear function, sigmoid function, hyperbolic tangent function, or another type of mathematical function that represents a threshold at which the node is activated. The aggregation function is a mathematical function that combines (e.g., sum, product, etc.) input signals to the node. An output of the aggregation function may be used as input to the activation function.

In another particular implementation, the model is represented on a layer-by-layer basis. For example, the hyperparameters define layers, and each layer includes layer data, such as a layer type and a node count. Examples of layer types include fully connected, long short-term memory (LSTM) layers, gated recurrent units (GRU) layers, and convolutional neural network (CNN) layers. In some implementations, all of the nodes of a particular layer use the same activation function and aggregation function. In such implementations, specifying the layer type and node count fully may describe the hyperparameters of each layer. In other implementations, the activation function and aggregation function of the nodes of a particular layer can be specified independently of the layer type of the layer. For example, in such implementations, one fully connected layer can use a sigmoid activation function and another fully connected layer (having the same layer type as the first fully connected layer) can use a tan h activation function. In such implementations, the hyperparameters of a layer include layer type, node count, activation function, and aggregation function. Further, a complete autoencoder is specified by specifying an order of layers and the hyperparameters of each layer of the autoencoder.

In a particular aspect, the genetic algorithm 510 may be configured to perform speciation. For example, the genetic algorithm 510 may be configured to cluster the models of the input set 520 into species based on “genetic distance” between the models. The genetic distance between two models may be measured or evaluated based on differences in nodes, activation functions, aggregation functions, connections, connection weights, layers, layer types, latent-space layers, encoders, decoders, etc. of the two models. In an illustrative example, the genetic algorithm 510 may be configured to serialize a model into a bit string. In this example, the genetic distance between models may be represented by the number of differing bits in the bit strings corresponding to the models. The bit strings corresponding to models may be referred to as “encodings” of the models.

After configuration, the genetic algorithm 510 may begin execution based on the input data 502. Parameters of the genetic algorithm 510 may include but are not limited to, mutation parameter(s), a maximum number of epochs the genetic algorithm 510 will be executed, a termination condition (e.g., a threshold fitness value that results in termination of the genetic algorithm 510 even if the maximum number of generations has not been reached), whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 510 uses a single mutation parameter or set of mutation parameters for all of the models. In such examples, the mutation parameter may impact how often, how much, and/or what types of mutations can happen to any model of the genetic algorithm 510. In alternative examples, the genetic algorithm 510 maintains multiple mutation parameters or sets of mutation parameters, such as for individual or groups of models or species. In particular aspects, the mutation parameter(s) affect crossover and/or mutation operations, which are further described below.

For an initial epoch of the genetic algorithm 510, the topologies of the models in the input set 520 may be randomly or pseudo-randomly generated within constraints specified by the configuration settings or by one or more architectural parameters. Accordingly, the input set 520 may include models with multiple distinct topologies. For example, a first model of the initial epoch may have a first topology, including a first number of input nodes associated with a first set of data parameters, a first number of hidden layers including a first number and arrangement of hidden nodes, one or more output nodes, and a first set of interconnections between the nodes. In this example, a second model of the initial epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes. Further, one or more layers of the first model can be of a different layer type than one or more layers of the second model. For example, the first model can be a feedforward model, with no recurrent layers; whereas, the second model can include one or more recurrent layers.

The genetic algorithm 510 may automatically assign an activation function, an aggregation function, a bias, connection weights, etc. to each model of the input set 520 for the initial epoch. In some aspects, the connection weights are initially assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes or layers of a model may have different types of activation functions. Aggregation functions may similarly be randomly or pseudo-randomly assigned for the models in the input set 520 of the initial epoch. Thus, the models of the input set 520 of the initial epoch may have different topologies (which may include different input nodes corresponding to different input data fields if the data set includes many data fields) and different connection weights. Further, the models of the input set 520 of the initial epoch may include nodes having different activation functions, aggregation functions, and/or bias values/functions.

During execution, the genetic algorithm 510 performs fitness evaluation 540 and evolutionary operations 550 on the input set 520. In this context, fitness evaluation 540 includes evaluating each model of the input set 520 using a fitness function 542 to determine a fitness function value 544 (“FF values” in FIG. 5) for each model of the input set 520. The fitness function values 544 are used to select one or more models of the input set 520 to modify using one or more of the evolutionary operations 550. In FIG. 5, the evolutionary operations 550 include mutation operations 552, crossover operations 554, and extinction operations 556, each of which is described further below.

During the fitness evaluation 540, each model of the input set 520 is tested based on the input data 502 to determine a corresponding fitness function value 544. For example, a first portion 504 of the input data 502 may be provided as input data to each model, which processes the input data (according to the network topology, connection weights, activation function, etc., of the respective model) to generate output data. The output data of each model is evaluated using the fitness function 542 and the first portion 504 of the input data 502 to determine how well the model modeled the input data 502. In some examples, fitness of a model is based on reliability of the model, performance of the model, complexity (or sparsity) of the model, size of the latent space, or a combination thereof.

In a particular aspect, fitness evaluation 540 of the models of the input set 520 is performed in parallel. To illustrate, the system 500 may include devices, processors, cores, and/or threads 580 in addition to those that execute the genetic algorithm 510 and the optimization trainer 560. These additional devices, processors, cores, and/or threads 580 can perform the fitness evaluation 540 of the models of the input set 520 in parallel based on a first portion 504 of the input data 502 and may provide the resulting fitness function values 544 to the genetic algorithm 510.

The mutation operation 552 and the crossover operation 554 are highly stochastic under certain constraints and a defined set of probabilities optimized for model building, which produces reproduction operations that can be used to generate the output set 530, or at least a portion thereof, from the input set 520. In a particular implementation, the genetic algorithm 510 utilizes intra-species reproduction (as opposed to inter-species reproduction) in generating the output set 530. In other implementations, inter-species reproduction may be used in addition to or instead of intra-species reproduction to generate the output set 530. Generally, the mutation operation 552 and the crossover operation 554 are selectively performed on models that are more fit (e.g., have higher fitness function values 544, fitness function values 544 that have changed significantly between two or more epochs, or both).

The extinction operation 556 uses a stagnation criterion to determine when a species should be omitted from a population used as the input set 520 for a subsequent epoch of the genetic algorithm 510. Generally, the extinction operation 556 is selectively performed on models that satisfy a stagnation criteria, such as models that have low fitness function values 544, fitness function values 544 that have changed little over several epochs, or both.

In accordance with the present disclosure, cooperative execution of the genetic algorithm 510 and the optimization trainer 560 is used to arrive at a solution faster than would occur by using a genetic algorithm 510 alone or an optimization trainer 560 alone. Additionally, in some implementations, the genetic algorithm 510 and the optimization trainer 560 evaluate fitness using different data sets, with different measures of fitness, or both, which can improve fidelity of operation of the final model. To facilitate cooperative execution, a model (referred to herein as a trainable model 532 in FIG. 5) is occasionally sent from the genetic algorithm 510 to the optimization trainer 560 for training. In a particular implementation, the trainable model 532 is based on crossing over and/or mutating the fittest models (based on the fitness evaluation 540) of the input set 520. In such implementations, the trainable model 532 is not merely a selected model of the input set 520; rather, the trainable model 532 represents a potential advancement with respect to the fittest models of the input set 520.

The optimization trainer 560 uses a second portion 506 of the input data 502 to train the connection weights and biases of the trainable model 532, thereby generating a trained model 562. The optimization trainer 560 does not modify the architecture of the trainable model 532.

During optimization, the optimization trainer 560 provides a second portion 506 of the input data 502 to the trainable model 532 to generate output data. The optimization trainer 560 performs a second fitness evaluation 550 by comparing the data input to the trainable model 532 to the output data from the trainable model 532 to determine a second fitness function value 554 based on a second fitness function 552. The second fitness function 552 is the same as the first fitness function 542 in some implementations and is different from the first fitness function 542 in other implementations. In some implementations, the optimization trainer 560 or portions thereof is executed on a different device, processor, core, and/or thread than the genetic algorithm 510. In such implementations, the genetic algorithm 510 can continue executing additional epoch(s) while the connection weights of the trainable model 532 are being trained by the optimization trainer 560. When training is complete, the trained model 562 is input back into (a subsequent epoch of) the genetic algorithm 510, so that the positively reinforced “genetic traits” of the trained model 562 are available to be inherited by other models in the genetic algorithm 510.

In implementations in which the genetic algorithm 510 employs speciation, a species ID of each of the models may be set to a value corresponding to the species that the model has been clustered into. A species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 510 may maintain a data structure that tracks the fitness of each species across multiple epochs. Based on the species fitness, the genetic algorithm 510 may identify the “fittest” species, which may also be referred to as “elite species.” Different numbers of elite species may be identified in different embodiments.

In a particular aspect, the genetic algorithm 510 uses species fitness to determine if a species has become stagnant and is therefore to become extinct. As an illustrative non-limiting example, the stagnation criterion of the extinction operation 556 may indicate that a species has become stagnant if the fitness of that species remains within a particular range (e.g., +/−5%) for a particular number (e.g., 5) of epochs. If a species satisfies a stagnation criterion, the species and all underlying models may be removed from subsequent epochs of the genetic algorithm 510.

In some implementations, the fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.”

The output set 530 of the epoch is generated based on the input set 520 and the evolutionary operation 550. In the illustrated example, the output set 530 includes the same number of models as the input set 520. In some implementations, the output set 530 includes each of the “overall elite” models and each of the “elite member” models. Propagating the “overall elite” and “elite member” models to the next epoch may preserve the “genetic traits” that resulted in such models being assigned high fitness values.

The rest of the output set 530 may be filled out by random reproduction using the crossover operation 554 and/or the mutation operation 552. After the output set 530 is generated, the output set 530 may be provided as the input set 520 for the next epoch of the genetic algorithm 510.

After one or more epochs of the genetic algorithm 510 and one or more rounds of optimization by the optimization trainer 560, the system 500 selects a particular model or a set of models as the final model (e.g., a model that is executable to perform one or more of the model-based operations of FIGS. 1-4). For example, the final model may be selected based on the fitness function values 544, 554. For example, a model or set of models having the highest fitness function value 544 or 554 may be selected as the final model. When multiple models are selected (e.g., an entire species is selected), an ensembler can be generated (e.g., based on heuristic rules or using the genetic algorithm 510) to aggregate the multiple models. In some implementations, the final model can be provided to the optimization trainer 560 for one or more rounds of optimization after the final model is selected. Subsequently, the final model can be output for use with respect to other data (e.g., real-time data).

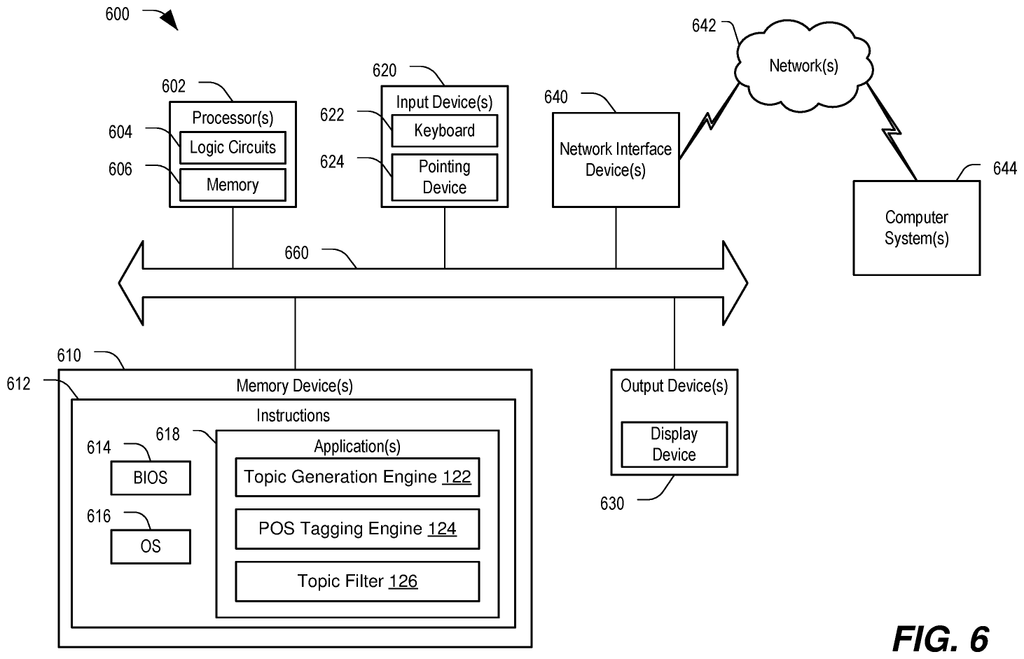

FIG. 6 is a block diagram of a particular computer system 600 configured to initiate, perform, or control one or more of the operations described with reference to FIGS. 1-5. For example, the computer system 600 may include, or be included within, one or more of the devices, wide area wireless networks, or servers described with reference to FIGS. 1-5. The computer system 600 can also be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. In some examples, the computer system 600, or at least components thereof, are included in a device that is associated with a battery or a cell, such as a vehicle, a device associated with a battery-based electrical grid, etc. Further, while a single computer system 600 is illustrated, the term “system” includes any collection of systems or sub-systems that individually or jointly execute a set, or multiple sets, of instructions to perform one or more computer functions.

While FIG. 6 illustrates one example of the particular computer system 600, other computer systems or computing architectures and configurations may be used for carrying out the operations disclosed herein. The computer system 600 includes one or more processors 602. Each processor of the one or more processors 602 can include a single processing core or multiple processing cores that operate sequentially, in parallel, or sequentially at times and in parallel at other times. Each processor of the one or more processors 602 includes circuitry defining a plurality of logic circuits 604, working memory 606 (e.g., registers and cache memory), communication circuits, etc., which together enable the processor to control the operations performed by the computer system 600 and enable the processor to generate a useful result based on analysis of particular data and execution of specific instructions.

The processor(s) 602 are configured to interact with other components or subsystems of the computer system 600 via a bus 660. The bus 660 is illustrative of any interconnection scheme serving to link the subsystems of the computer system 600, external subsystems or device, or any combination thereof. The bus 660 includes a plurality of conductors to facilitate communication of electrical and/or electromagnetic signals between the components or subsystems of the computer system 600. Additionally, the bus 660 includes one or more bus controller or other circuits (e.g., transmitters and receivers) that manage signaling via the plurality of conductors and that cause signals sent via the plurality of conductors to conform to particular communication protocols.

The computer system 600 also includes one or more memory devices 610. The memory devices 610 include any suitable computer-readable storage device depending on, for example, whether data access needs to be bi-directional or unidirectional, speed of data access required, memory capacity required, other factors related to data access, or any combination thereof. Generally, the memory devices 610 include some combination of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the memory devices 610 include circuits and structures and are not merely signals or other transitory phenomena.

The memory device(s) 610 store instructions 612 that are executable by the processor(s) 602 to perform various operations and functions. The instructions 612 include instructions to enable the various components and subsystems of the computer system 600 to operate, interact with one another, and interact with a user, such as an input/output system (BIOS) 614 and an operating system (OS) 616. Additionally, the instructions 612 include one or more applications 618, scripts, or other program code to enable the processor(s) 602 to perform the operations described herein. For example, the one or more applications 618 can perform the operations associated with the topic generation engine 122, the POS tagging engine 124, and the topic filter 126.

In FIG. 6, the computer system 600 also includes one or more output devices 630, one or more input devices 620, and one or more network interface devices 640. Each of the output device(s) 630, the input device(s) 620, and the network interface device(s) 640 can be coupled to the bus 660 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 630, the input device(s) 620, the network interface device(s) 640 is coupled to or integrated within a housing with the processor(s) 602 and the memory devices 610, in which case the connections to the bus 660 can be internal, such as via an expansion slot or other card-to-card connector. In other implementations, the processor(s) 602 and the memory devices 610 are integrated within a housing that includes one or more external ports, and one or more of the output device(s) 630, the input device(s) 620, the network interface device(s) 640 is coupled to the bus 660 via the external port(s).

Examples of the output device(s) 630 include a display device, one or more speakers, a printer, a television, a projector, or another device to provide an output of data in a manner that is perceptible by a user. Examples of the input device(s) 620 include buttons, switches, knobs, a keyboard 622, a pointing device 624, a biometric device, a microphone, a motion sensor, or another device to detect user input actions. The pointing device 624 includes, for example, one or more of a mouse, a stylus, a track ball, a pen, a touch pad, a touch screen, a tablet, another device that is useful for interacting with a graphical user interface, or any combination thereof.

The network interface device(s) 640 is configured to enable the computer system 600 to communicate with one or more other computer systems 644 via one or more networks 642. The network interface device(s) 640 encode data in electrical and/or electromagnetic signals that are transmitted to the other computer system(s) 644 using pre-defined communication protocols. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

It is to be understood that the division and ordering of steps described herein is for illustrative purposes only and is not considered limiting. In alternative implementations, certain steps may be combined and other steps may be subdivided into multiple steps. Moreover, the ordering of steps may change.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Particular aspects of the disclosure are described below in the following examples:

### Example 1

A method comprising: applying, by one or more processors, a topic model to a document to generate a plurality of topics for the document, each topic of the plurality of topics including a corresponding group of words in the document; performing a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and filtering the particular topic from the plurality of topics in response to a determination that each word of the particular topic is tagged with the first label.

### Example 2

The method of Example 1, wherein filtering the particular topic from the plurality of topics comprises removing the particular topic from the plurality of topics.

### Example 3

The method of any of Examples 1 to 2, further comprising: performing the POS tagging operation on the document to tag each word of a second particular topic of the plurality of topics with the first label or the second label; determining that a subset of the words of the second particular topic are tagged with the first label; and filtering the subset of the words of the second particular topic from the second particular topic to generate a filtered second particular topic, the second particular topic usable to classify the document.

### Example 4

The method of any of Examples 1 to 3, wherein filtering the subset of the words of the second particular topic comprises removing the subset of the words of the second particular topic from the second particular topic.

### Example 5

The method of any of Examples 1 to 4, wherein the topic model comprises a Correlation Explanation (CorEx) topic model.

### Example 6

The method of any of Examples 1 to 5, wherein each topic of the plurality of topics is generated based on one or more anchor words designated by a user.

### Example 7

The method of any of Examples 1 to 6, wherein the first part of speech corresponds to a verb.

### Example 8

The method of any of Examples 1 to 6, wherein the first part of speech corresponds to one of an adjective, an adverb, a pronoun, a preposition, a conjunction, a determiner, or an interjection, and wherein the second part of speech corresponds to a noun or a pronoun.

### Example 9

The method of any of Examples 1 to 6, wherein applying the topic model to the document comprises: generating input data representing text of the document; and providing the input data to the topic model, where the topic model identifies words or phrases that are representative of information content of the document as the plurality of topics.

### Example 10

A device comprising: one or more processors; and one or more memory devices accessible to the one or more processors, the one or more memory devices storing instructions that are executable by the one or more processors to cause the one or more processors to: apply a topic model to a document to generate a plurality of topics for the document, each topic of the plurality of topics including a corresponding group of words in the document; perform a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and filter the particular topic from the plurality of topics in response to a determination that each word of the particular topic is tagged with the first label.

### Example 11

The device of Example 10, wherein, to filter the particular topic from the plurality of topics, the instructions are executable to cause the one or more processors to remove the particular topic from the plurality of topics.

### Example 12

The device of any of Examples 10 to 11, wherein the instructions are further executable by the one or more processors to cause the one or more processors to: perform the POS tagging operation on the document to tag each word of a second particular topic of the plurality of topics with the first label or the second label; determine that a subset of the words of the second particular topic are tagged with the first label; and filter the subset of the words of the second particular topic from the second particular topic to generate a filtered second particular topic, the second particular topic usable to classify the document.

### Example 13

The device of any of Examples 10 to 12, wherein, to filter the subset of the words of the second particular topic, the instructions are executable to cause the one or more processors to remove the subset of the words of the second particular topic from the second particular topic.

### Example 14

The device of any of Examples 10 to 13, wherein the topic model comprises a Correlation Explanation (CorEx) topic model.

### Example 15

The device of any of Examples 10 to 14, wherein each topic of the plurality of topics is generated based on one or more anchor words designated by a user.

### Example 16

The device of any of Examples 10 to 15, wherein the first part of speech corresponds to a verb.

### Example 17

The device of any of Examples 10 to 15, wherein the first part of speech corresponds to one of an adjective, an adverb, a pronoun, a preposition, a conjunction, a determiner, or an interjection, and wherein the second part of speech corresponds to a noun or a pronoun

### Example 18

The device of any of Examples 10 to 17, wherein, to apply to topic model to the document, the instructions are further executable by the one or more processors to cause the one or more processors to: generate input data representing text of the document; and provide the input data to the topic model, wherein the topic model identifies words or phrases that are representative of information content of the document as the plurality of topics.

### Example 19

A computer-readable storage device storing instructions that are executable by one or more processors to perform operations comprising: applying a topic model to a document to generate a plurality of topics for the document, each topic of the plurality of topics including a corresponding group of words in the document; performing a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and filtering the particular topic from the plurality of topics in response to a determination that each word of the particular topic is tagged with the first label.

### Example 20

The computer-readable storage device of Example 19, wherein filtering the particular topic from the plurality of topics comprises removing the particular topic from the plurality of topics.

### Example 21

The computer-readable storage device of any of Examples 19 to 20, wherein the operations further comprise: performing the POS tagging operation on the document to tag each word of a second particular topic of the plurality of topics with the first label or the second label; determining that a subset of the words of the second particular topic are tagged with the first label; and filtering the subset of the words of the second particular topic from the second particular topic to generate a filtered second particular topic, the second particular topic usable to classify the document.

### Example 22

The computer-readable storage device of any of Examples 19 to 21, wherein filtering the subset of the words of the second particular topic comprises removing the subset of the words of the second particular topic from the second particular topic.

### Example 23

The computer-readable storage device of any of Examples 19 to 22, wherein the topic model comprises a Correlation Explanation (CorEx) topic model.

### Example 24

The computer-readable storage device of any of Examples 19 to 23, wherein each topic of the plurality of topics is generated based on one or more anchor words designated by a user.

### Example 25

The computer-readable storage device of any of Examples 19 to 24, wherein the first part of speech corresponds to a verb.

### Example 26

The computer-readable storage device of any of Examples 19 to 24, wherein the first part of speech corresponds to one of an adjective, an adverb, a pronoun, a preposition, a conjunction, a determiner, or an interjection.

### Example 27

The computer-readable storage device of any of Examples 19 to 24, wherein the second part of speech corresponds to a noun or a pronoun.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
applying, by one or more processors, a topic model to a document to generate a plurality of topics for the document, each topic of the plurality of topics including a corresponding group of words in the document;
performing a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and
filtering the particular topic from the plurality of topics in response to a determination that each word of the particular topic is tagged with the first label.

2. The method of claim 1, wherein filtering the particular topic from the plurality of topics comprises removing the particular topic from the plurality of topics.

3. The method of claim 1, further comprising:
performing the POS tagging operation on the document to tag each word of a second particular topic of the plurality of topics with the first label or the second label;
determining that a subset of the words of the second particular topic are tagged with the first label; and
filtering the subset of the words of the second particular topic from the second particular topic to generate a filtered second particular topic, the second particular topic usable to classify the document.

4. The method of claim 3, wherein filtering the subset of the words of the second particular topic comprises removing the subset of the words of the second particular topic from the second particular topic.

5. The method of claim 1, wherein the topic model comprises a Correlation Explanation (CorEx) topic model.

6. The method of claim 5, wherein each topic of the plurality of topics is generated based on one or more anchor words designated by a user.

7. The method of claim 1, wherein the first part of speech corresponds to a verb.

8. The method of claim 1, wherein the first part of speech corresponds to one of an adjective, an adverb, a pronoun, a preposition, a conjunction, a determiner, or an interjection, and wherein the second part of speech corresponds to a noun or a pronoun.

9. The method of claim 1, wherein applying the topic model to the document comprises:
generating input data representing text of the document; and
providing the input data to the topic model, wherein the topic model identifies words or phrases that are representative of information content of the document as the plurality of topics.

10. A device comprising:
one or more processors; and
one or more memory devices accessible to the one or more processors, the one or more memory devices storing instructions that are executable by the one or more processors to cause the one or more processors to:
apply a topic model to a document to generate a plurality of topics for the document, each topic of the plurality of topics including a corresponding group of words in the document;
perform a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and
filter the particular topic from the plurality of topics in response to a determination that each word of the particular topic is tagged with the first label.

11. The device of claim 10, wherein, to filter the particular topic from the plurality of topics, the instructions are executable to cause the one or more processors to remove the particular topic from the plurality of topics.

12. The device of claim 10, wherein the instructions are further executable by the one or more processors to cause the one or more processors to:
perform the POS tagging operation on the document to tag each word of a second particular topic of the plurality of topics with the first label or the second label;
determine that a subset of the words of the second particular topic are tagged with the first label; and
filter the subset of the words of the second particular topic from the second particular topic to generate a filtered second particular topic, the second particular topic usable to classify the document.

13. The device of claim 12, wherein, to filter the subset of the words of the second particular topic, the instructions are executable to cause the one or more processors to remove the subset of the words of the second particular topic from the second particular topic.

14. The device of claim 10, wherein the topic model comprises a Correlation Explanation (CorEx) topic model.

15. The device of claim 14, wherein each topic of the plurality of topics is generated based on one or more anchor words designated by a user.

16. The device of claim 10, wherein the first part of speech corresponds to a verb.

17. The device of claim 10, wherein the first part of speech corresponds to one of an adjective, an adverb, a pronoun, a preposition, a conjunction, a determiner, or an interjection, and wherein the second part of speech corresponds to a noun or a pronoun.

18. The device of claim 10, wherein, to apply to topic model to the document, the instructions are further executable by the one or more processors to cause the one or more processors to:
generate input data representing text of the document; and
provide the input data to the topic model, wherein the topic model identifies words or phrases that are representative of information content of the document as the plurality of topics.

19. A computer-readable storage device storing instructions that are executable by one or more processors to perform operations comprising:
applying a topic model to a document to generate a plurality of topics for the document, each topic of the plurality of topics including a corresponding group of words in the document;
performing a parts of speech (POS) tagging operation on the document to tag each word of a particular topic of the plurality of topics with a first label or a second label, wherein words tagged with the first label are designated as a first part of speech, and wherein words tagged with the second label are designated as a second part of speech; and
filtering the particular topic from the plurality of topics in response to a determination that each word of the particular topic is tagged with the first label.

20. The computer-readable storage device of claim 19, wherein filtering the particular topic from the plurality of topics comprises removing the particular topic from the plurality of topics.
